(19) United States
(12) Patent Application Publication
(10) Pub. No.: US 2018/0114255 A1
(43) Pub. Date: Apr. 26, 2018

(54) SYSTEM AND METHOD FOR RANKING AGENTS WITHIN COMMODITY ENDORSEMENTS

(71) Applicant: Kalin Georgiev Nikolov, Sofia (BG)

(72) Inventor: Kalin Georgiev Nikolov, Sofia (BG)

(21) Appl. No.: 15/553,145

(22) PCT Filed: Feb. 25, 2015
(86) PCT No.: PCT/EP2015/000433

§ 371 Date: Aug. 23, 2017

(51) Int. Cl. G06Q 30/02; G06Q 30/08; G06Q 50/16; G06F 17/30

(52) U.S. Cl. CPC G06Q 30/0282; G06Q 30/0277; G06F 17/30864; G06Q 50/16; G06Q 30/0275; G06Q 30/08

(57) ABSTRACT

What is disclosed is a computer system for arranging and facilitating transactions involving certain types of liquid non-fungible commodities, pertaining to market agents that aim to contact and engage with potential customers and a method thereof. The method enables the agents to compete against each other for privileged positioning in an endorsement of an individual commodity or group of commodities. An Agent's rank within an endorsement is set by means of an auction in which agents bid and compete for a specific and concrete rank within the corresponding endorsement. The system and the method are intended to be integrated into other information systems and/or communication networks containing or managing listings of and information about commodities and, which enable customers to query for commodities in order to establish contact with agents.

### TECHNICAL FIELD

This invention relates generally to systems, search engines, advertising services and methods thereof in the field of real estate that can be of assistance in the positioning of Agents as preferred contacts to facilitate transactions involving a selected set of Commodities.

### BACKGROUND OF THE INVENTION

Computer-based systems aiming to assist the work of Agents in field of transactions with commodities, particularly in the field of real estate, have been evolving over the years with varying degrees of success. The present interdisciplinary invention benefits Agents by providing them with the technical means to claim and acquire a priority association with specific instances of certain Commodity types. The two fields that constitute the background of this invention are:
Search engines that: (1) provide Prospects with the ability to locate information about Commodity instances matching specific search criteria; and, (2) promote contact (a “Lead”) between a Prospect interested in a Commodity and Agents that facilitate the corresponding transactions. Such systems, for example, are real estate websites for property buyers, sellers, renters, and real estate licensees.
Advertising services that allow Agents to compete for a promotion to prospects looking for information about certain Commodities. Examples of such systems include the advertisement identification management in a global and/or social network.

The various instances of the two types of systems referred to above exhibit a number of deficiencies that this invention resolves.
Locking and Disallowing Competition: Search engines (e.g., real estate websites) that charge Agents to generate a fixed number of Leads to Prospects are bound by the limited number of Leads that can be generated for any given period. This is because the total number of views of the information about any given Commodity for any given time period are limited within each system, which also imposes a limit on the Leads pertaining to the Commodity. Commodities, therefore, are being “locked” to Agents purchasing the corresponding service on a first-come first-serve basis. Since these locked Commodities are unavailable for other Agents to access until a time period has elapsed, those Agents cannot “compete” for them until the locks expire and the associated Commodities are once more available for transactions such as sale.
Disallowing specialization and locality of operations: Commodity search engines (such as real estate websites) identify Commodities by matching general search criteria (e.g., a zip code). When larger scale Agents “lock up” general Commodity segments (matching a wide range of search criteria), smaller scale Agents operating in a specific locality (e.g., a particular neighborhood) or possessing specific expertise (e.g., modernist interior design) cannot successfully compete for exclusivity in their specific areas of operation or interest. This is because the local and specific criteria may be special case of the wider criteria, which has been used to “lock up” the respective Commodities.
Approximate matching: Advertising services that allow Agents to compete for a given promotion to Prospects generally rely on identifiers, including keywords. Such advertising services allow Agents to bid on specific identifiers (i.e., character strings specifying search criteria) and to participate in auctions for a Prospect's search in order to determine the priority with which Agents will be promoted to the Prospect. Since Agents are unable to specify individual and concrete objects, including Commodities and Prospects, that constitute their target interests, there are no direct guarantees that the resulting promotion will be a true match to both the Prospect's actual interests and the Agent's target Prospects. Furthermore, as there is rarely an exact match between the identifiers that Agents bid on and the identifiers that Prospects use in their queries, Agents are ranked according to similarity criteria, which results in probabilistic ranking. Agents are unable, therefore, to compete for a position in the promotion pertaining to a specific Commodity.

The invention described herein overcomes the above issues by providing the solutions listed below:
Result Guarantees: Agents bid for a ranking position in an endorsement of a specific Commodity and their position is guaranteed to an Agent so long as he or she is the primary bidder for the corresponding ranking position.
Micro Criteria: Agents can specify identifiers of the Commodities they are interested in (local area and/or detailed characteristics) or even select individual Commodities. Agents can then compete for exclusivity of the specific Commodities they have so identified.
No Locking: The locking of Commodities is eliminated by allowing any Agent at any time to offer a higher bid for a specific set (based on search criteria) of Commodities, thereby winning a privileged presence in the Commodity endorsement displayed to Prospects.
Open Market: Market openness is guaranteed in two ways: (1) Agents have access to detailed and specific information about the current bids made for Commodities matching their interests. Agents are advised about the minimal bid that they could place for their desired ranking position; (2) Agents have access to a “heat map” providing real-time visualization of the available Commodities and the amounts of the current highest bids.
Precise matching: Rather than speculating about the most probable identifiers and search criteria used by Prospects looking for Commodities of target interest to an Agent, Agents are provided with a concise but comprehensive list of features that identify Commodities. Agents are allowed to choose various defining features from that list and to use them to specify their bids.

### DISCLOSURE OF THE INVENTION

The present invention will be disclosed by means of the following detailed description of its comprising embodiments, including specific definitions, marked as such in the applicable text.
1. A summary of the industrial applicability of the invention, the systems and modules that the invention comprises, the business processes and methods involved, and the various user roles interacting with the Invention;
2. Schematic diagrams of the data and modules of exemplary computer systems and networks which represent embodiments of the present Invention;
3. Schematic diagrams of exemplary processes being a part of the embodiments of the present Invention;
4. Exemplary screenshots of user interfaces of a sample implementation of the embodiments described herein;
5. A mathematical definition of the class of procedures that are implemented by core components of the Invention;

### 1. Summary of Business Domain, Business Processes, and Roles

The computer system specified herein (“System”) and method (“Method”) thereof pertains to market agents (“Agents”) that aim to contact and engage with potential customers (“Prospects”) with the goal of arranging for and facilitating transactions involving certain types of liquid non-fungible commodities (“Commodities”).

The System and Method enable Agents to compete against each other for privileged positioning in an endorsement of an individual Commodity or group of Commodities (“Endorsement”).

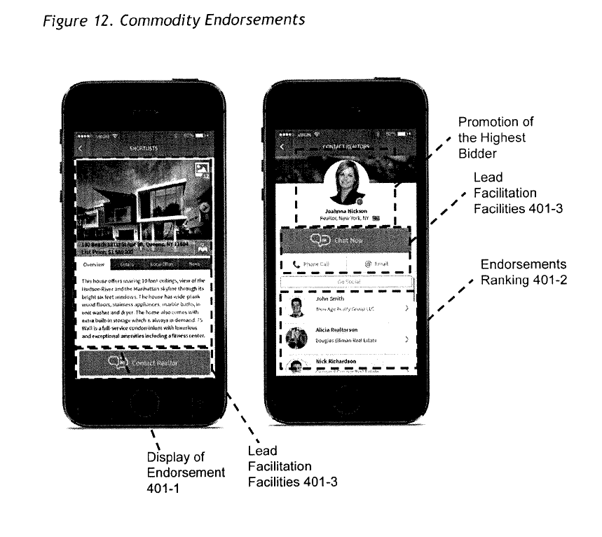

As demonstrated in FIG. 12 hereof, Endorsements of Commodities (e.g. ads or dedicated web pages) can be published, displayed, or presented on a digital medium (including, but not limited to, a website, mobile application, or a screen) or on a printed medium (including, but not limited to, a poster, a newspaper, a magazine, or a book).

The System and the Method provide for the participating Agents to be promoted within Commodity Endorsements (FIG. 12). The promotion of Agents is based on a ranking wherein Agents with higher ranks receive privileged visual display within Endorsements, thereby targeting Prospects viewing the corresponding Endorsement.

Agents' ranking within Endorsements pertaining to a specific Commodity or group of Commodities is determined by means of an auction in which Agents bid and compete for a promotion within the corresponding Endorsement or group of Endorsements.

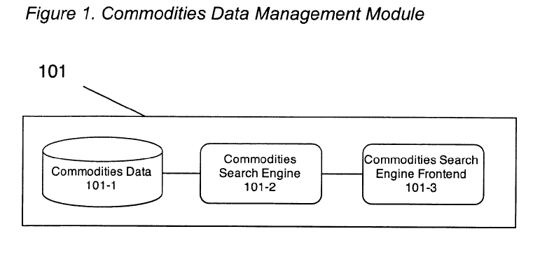

In one of the embodiments of the invention as described in FIGS. 1-5, Method and System are integrated into an information system containing and managing listings of and information about Commodities, thereby enabling Prospects to query for Commodities in order to establish contact with Agents.

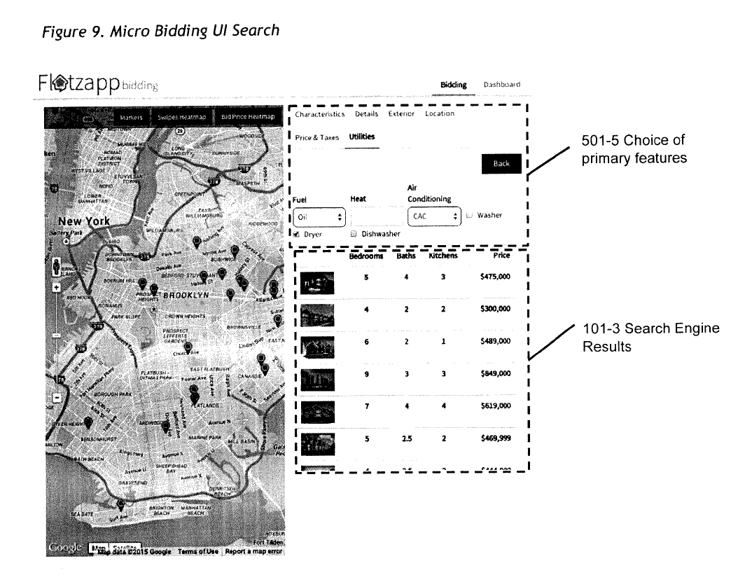

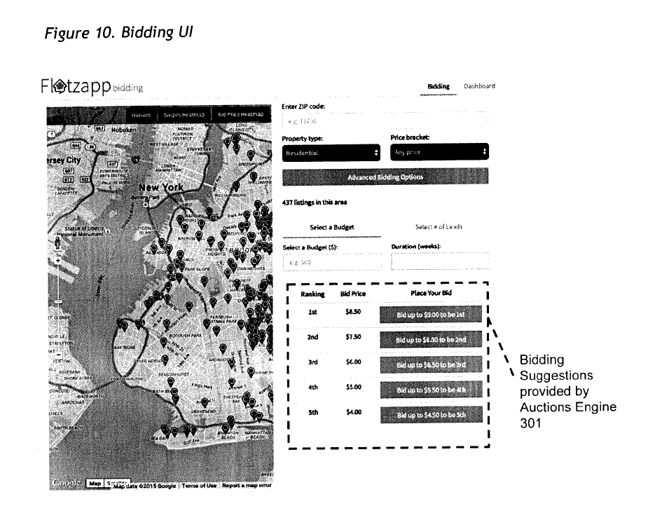

As demonstrated in FIGS. 9 and 10, Agents impose a filter (“Filter”) on the list of available Commodities, representing a set of criteria identifying specific features of the commodities (“Criteria”), thereby selecting groups of Commodities (“Target Commodities”) for which Agents request to obtain privileged visual display on all Endorsements of any Commodity in the group.

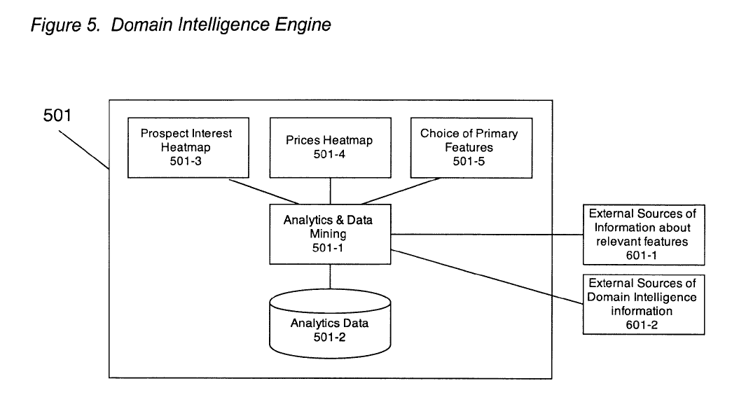

In one of its embodiments, as demonstrated on FIG. 5 hereof, the invention provides Agents with specific Criteria which are strictly relevant to the types of Commodities, thereby supporting Agents to optimize the identification of the Agents' Target Commodities.

Discrete monetary units (“Monetary Units”) are used by Agents within System for two purposes:
1. Agent may place a bid of a fixed number of monetary units to participate in an auction for a rank within an Endorsement;
2. Agent is charged a fixed number of monetary units for every contact by a Prospect as a result of Agent's association with a specific rank and promotion within an Endorsement.

Monetary units may be obtained within the System against valid payment means, including but not limited to legal tender, cash or non-cash methods of payment, bank transfer orders, third-party payment systems, electronic funds transfer, or digital currencies.

2. Schematic Diagrams of the Data and Modules of Exemplary Computer Systems which Represent Embodiments of the Present Invention;

FIG. 1. (“Commodities Data Management Module”) represents one of the embodiments of the System pertaining to the input, management, and retrieval of information about Commodities (101).

This module can store the necessary information about the Commodities accessible to Prospects and competing Agents. The module can be comprised of several main components, including, but not limited to:
A database component for information storage (101-1);
A search engine for the retrieval of Commodities relevant to specific search queries (101-2);
Search engine frontend providing Prospects and Agents with the ability to perform search queries (101-3).

The specific responsibility of this module within the System is the management of data and the handling of search queries for information about Commodities.

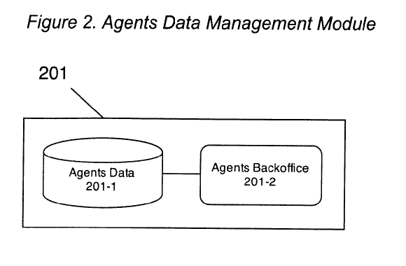

FIG. 2. (“Agents Data Management Module”) represents one of the embodiments of the System pertaining to the input, management, and retrieval of information about Agents (201).

This module can store the necessary information about the Agents that Endorsement Engine (401) can make available to Prospects and that the Auctions Engine (301) may need for its operations. Such module can be comprised of the several main components, including, but not limited to:
A database component for information storage (201-1);
A back office (201-1) allowing agents to input and update their personal information and the information required by other modules of the system, such as the Auctions Engine (301).

The specific responsibility of this module within the System is the management of data about Agents and the user interfaces provided to Agents to input and update that data.

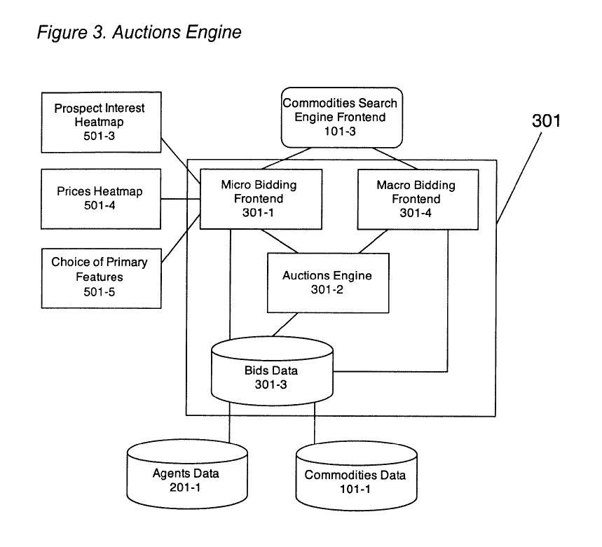

FIG. 3. (“Auctions Engine”) represents one of the embodiments of the System pertaining to the facilities of the competition process involving Agents and their Target Commodities (301).

This module can store the necessary information, provide the necessary facilities, and perform the necessary operations for the process of Agents competition for the privileged visual display within the Commodity Endorsements related to the Agents' Target Commodities. Such module can be comprised of the several main components, including, but not limited to:
A database component for information storage (301-3); The Bidding Data database component 301-3 may contain references to the information stored in the database components of the Agents Data Management Module (201-2) and the Commodities Data Management Module (101-1);
An Auctions Engine (301-2) which performs all processes necessary for the management of the Bidding Configurations and Endorsement Rankings including the execution of the Ranking Algorithm. This Engine can feed the resulting data to all other components and modules of the System that need it;
A Micro Bidding user facing front end component 301-1 which: (1) aggregates the information available by the Domain Intelligence Engine 501 and the information about current Suggested Bids and (2) employs the facilities provided by the Commodities Search Engine. The access to aggregated information and searching capabilities is provided to Agents in order support the informed decision making process of identifying Target Commodities and placing bids for the privileged positioning within the Commodity Endorsements related to the Agents' Target Commodities;
A Macro bidding user facing front end component 301-4 which provides a query based search capability, thereby allowing for an accelerated, identification of a set of Target Commodities as compared to that required by the Micro Bidding UI 301-1 which is based on Criteria identifying specific features of the commodities. The Macro Bidding UI 301-4 may not need to access the benefits of the information provided by the Domain Intelligence Engine 501.

The specific responsibility of this module within the System is the management of data about current Bidding Configurations and Endorsements Ranking, as defined in section 5 (“A mathematical definition of the class of procedures that are implemented by core components of the Invention”), and the facilities required by the competition process for the privileged positioning within the Commodity Endorsements related to the Agents' Target Commodities.

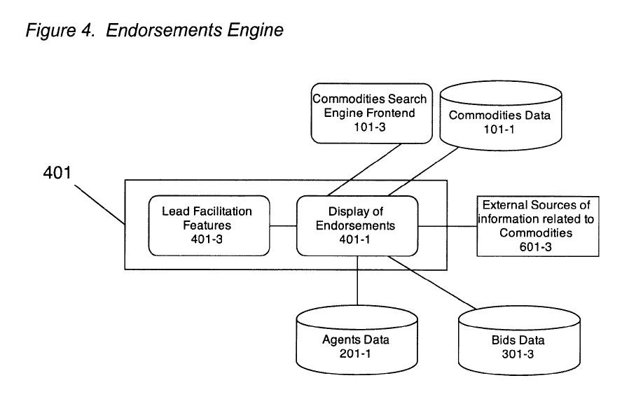

FIG. 4. (“Endorsements Engine”) represents one of the embodiments of the System pertaining to the presentation of Commodity Endorsements to Prospects, the facilitation of privileged Agent promotions within Commodity Endorsements, and the facilitation of direct contact between Prospects and Agents (401).

This module can implement the presentation of information about specific Commodities 101-1 in the form of Commodity Endorsements 401-1 in a way that is compelling to Prospects and that encourages Prospects to engage in a direct contact with Agents. The direct contact between Prospects and Agents can be facilitated by a variety of tools, including, but not limited to Instant Messaging, Email Exchange, Phone Calls, Disclosure of contact information, and others.

The necessary information describing Agents and the means for a direct contact with Agents 401-3 is incorporated in the Commodity Endorsement displays 401-1. The specific ranking of Agents within an endorsements is provided by the Auctions Engine 301 which retrieves the current Endorsement Ranks.

Commodity Endorsements can be presented on individual pages or sheets of information or as hints accompanying the Commodities Search Engine Frontend 101-3.

To further support the compelling nature of Commodity Endorsements, the display of the information about a specific Commodity instance 401-1 can be enhanced with information from external sources of information 601-3 that is relevant to the specific Commodity instance. Such information may include, for example, local offers, local news, and open source data.

FIG. 5. (“Domain Intelligence Engine”) represents one of the embodiments of the System pertaining to intelligence data about Commodities and the support of Agents in the process of identifying their Target Commodities by allowing them to access intelligence data and other types of automatic guidance (501).

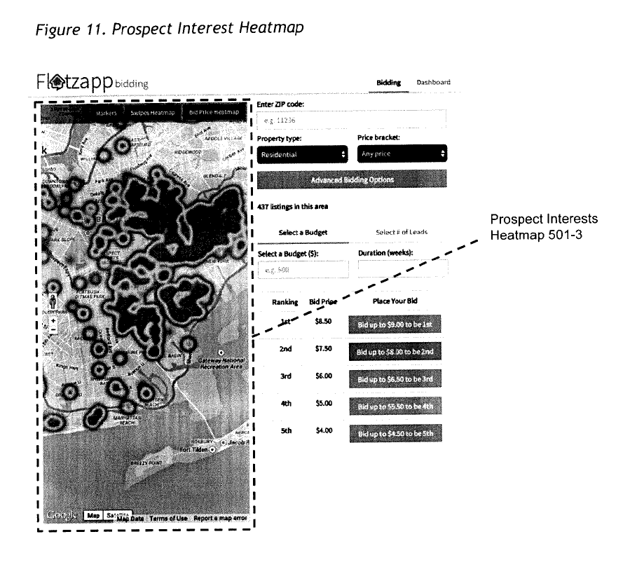

Data mining and general data analytics methods 501-1 can be implemented by this module to extract information about the behavior of Prospects and the current and past market trends. Within the module, a data intelligence engine can collect or access information generated by the other components of the System or by external sources 601-2. The results of this analysis can be presented to Agents and Prospects in the forms of:
A Prospect Interest Heatmap 501-3 displaying a visual projection of the search space of Commodities including some or all identifying Criteria (e.g. geographical location) and a color coded graphical overlay representing a measure of the interest of Prospects related to the corresponding Commodities as demonstrated in FIG. 11;
A Prices Heatmap 501-4 displaying a visual projection of the search space of Commodities including some or all identifying Criteria (e.g. geographical location) and a color coded graphical overlay representing the values of the current highest bids for the corresponding Commodities.

Another output of the Domain Intelligence Engine can be a list of the primary identifying Criteria of the corresponding Commodities 501-5. The list 501-5 is a concise but comprehensive collection of the type of features that distinguish the individual Commodity instances. This list is provided to Agents is used to support Agents to optimize the identification of their Target Commodities. The list is obtained by internal analytics methods or by access to external sources of information about relevant features 601-1.

The specific responsibility of this module within the System is the aggregation, analysis, and presentation of external and internal information about Prospect behavior, market trends, and primary Commodity features.

3. Schematic Diagrams of Exemplary Processes that are a Part of the Embodiments of the Present Invention

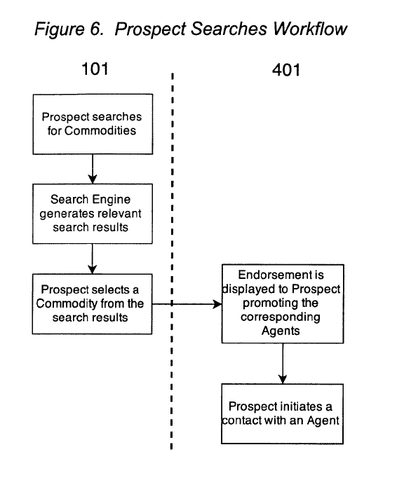

FIG. 6. (“Prospect Searches Workflow”) represents one of the embodiments of the System and Method pertaining to the workflow of Prospects searching for Commodities.

When Prospects search for Commodities they provide the corresponding search query to the Commodities Data Management Module 101. Based on that query, the Commodities Search Engine 101-2 generates a list of relevant Commodities. Prospects selects individual instances of Commodities from the search results list to view the corresponding Commodity Endorsement.

The Endorsement Engine 401 displays the corresponding Commodity Endorsement which contains the relevant information about the Commodity instance and promotes a direct contact with a ranked list of Agents 401-2, as demonstrated in FIG. 12. A lead is generated when a Prospect employs any of the direct contact facilities 401-3.

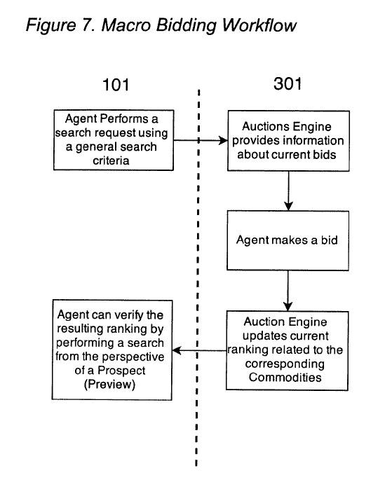

FIG. 7. (“Macro Bidding Workflow”) represents one of the embodiments of the System and Method pertaining to the workflow of Agents identifying their Target Commodities by the use of general queries.

Within the Macro Bidding scenario, Agents use general search query that are fed to the Commodities Search Engine 101-2 in order to identify the Agent's set of Target Commodities. By using the Macro bidding user facing front end component 301-4 Agents use a query based search capability, thereby allowing for an accelerated identification of a set of Target Commodities as compared to that required by the Micro Bidding UI 301-1 which is based on Criteria identifying specific features of the Commodities.

The Auctions Engine 301 provides the Agent with information about the current Suggested Bids, as defined in section 5 (“A mathematical definition of the class of procedures that are implemented by core components of the Invention”), for the identified Target Commodities via the Macro Bidding Frontend 301-4 which allows the Agent to determine the amount of their bid. After the bid is placed, the Auction Engine updates the current Bidding Configuration. The Agent can then review the resulting Endorsements Ranking by employing the facilities of the Commodities Data Management Module 101.

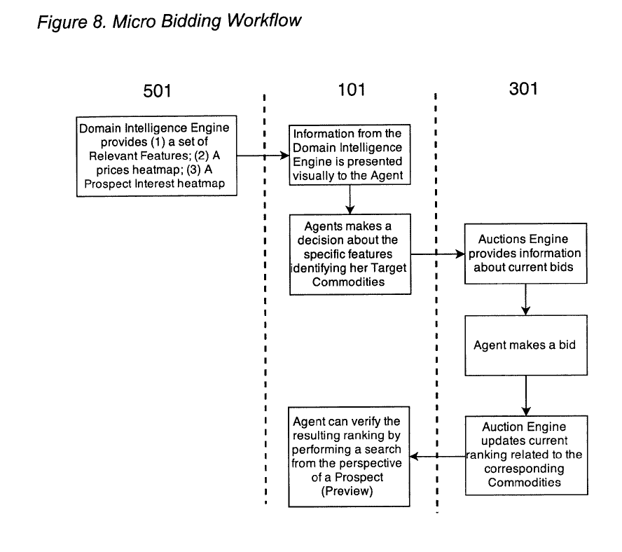

FIG. 8. (“Micro Bidding Workflow”) represents one of the embodiments of the System and Method pertaining to the workflow of Agents identifying their Target Commodities by making use of the intelligence and other aids provided by the Domain Intelligence Engine.

Within the Micro Bidding scenario, Agents use refined search Criteria that are fed to the Commodities Search Engine 101-2 in order to identify the Agent's set of Target Commodities. The means for the definition of refined search Criteria are provided by the Domain Intelligence Engine 501 and include a concise but comprehensive list of primary identifying Commodity futures 501-5 as well as summarized information about Prospects behavior and market trends 501-3 and 501-4.

Agents use the Micro bidding user facing front end component 301-1 by employing the facilities of the Commodities Data Management Module 101 in order to identify their set of Target Commodities.

The Auctions Engine 301 provides the Agent with information about the current Suggested Bids for the identified Target Commodities via the Micro Bidding Frontend 301-1 which allows the Agent to determine the amount of their bid. After the bid is placed, the Auction Engine updates the current Bidding Configuration. The Agent can then review the resulting Endorsements Ranking by employing the facilities of the Commodities Data Management Module 101.

### 4. Exemplary Screenshots of User Interfaces of a Sample Implementation of the Embodiments Described Herein;

FIG. 9. (“Micro Bidding UI Search”) represents an exemplary screenshot of user interfaces for one of the embodiments of the System and Method pertaining to the establishment of a bid by an Agent for the Agent's Target Commodities identified by detailed Criteria. The screenshot is of an exemplary application of the System and Method disclosed herein in the field of real estate sites for property buyers, sellers, renters, and real estate licensees.

The choice of primary features 501-5 provided by the Domain Intelligence Engine 501 is available to Agents in order to allow them to specify a refined list of Target Commodities. The available choice of features is integrated with the facilities of the Commodities Search Engine 101-2.

FIG. 10. (“Bidding UI”) represents an exemplary screenshot of user interfaces for one of the embodiments of the System and Method enabling Agents to place their bids within the Auctions Engine 301. The screenshot is of an exemplary implementation of the Method disclosed hereby in the field of real estate sites for property buyers, sellers, renters, and real estate licensees.

The Auctions Engine 301 provides the Agents with the Bidding Suggestions corresponding to the Target Commodities identified by the Agents. The Bidding UI allows Agents to specify the amount of their bids by choosing from a list of suggested bids or by a free input of a value of their choice. The value is then processed by the Auctions Engine 301-2.

FIG. 11. (“Prospect Interest Heatmap”) represents an exemplary screenshot of user interfaces for one of the embodiments of the System and Method pertaining to the presentation of Prospect Interest data by the Domain Intelligence Engine. The screenshot is of an exemplary implementation of the Method disclosed hereby in the field of real estate sites for property buyers, sellers, renters, and real estate licensees;

The Domain Intelligence Engine 501 provides Agents with access to a Prospect Interest Heatmap 501-3 displaying a visual projection of the search space of Commodities including some or all identifying criteria (e.g. geographical location) and a color coded graphical overlay representing a measure of the interest of Prospects related to the corresponding Commodities. The Agents can use that information to refine their definition of Target Commodities using the Micro Bidding system 301-1.

FIG. 12. (“Commodity Endorsement”) is an exemplary screen shot of user interfaces for the presentation of Commodity Endorsements including promotions of Agents and the facilities for Prospects to establish a contact with Agents in accordance with exemplary embodiments of the present Invention. The screenshot is of an exemplary implementation of the Method disclosed hereby in the field of real estate sites for property buyers, sellers, renters, and real estate licensees.

The Endorsement Ranking of Agents within the Commodity Endorsement is achieved by visual techniques highlighting the current highest bidder for the corresponding Commodity. The provides means of direct contact between the Prospect and the Agent include Instant Messaging, Phone Calls, and Email Exchange. The screenshot illustrates a sample implementation of the Display of Endorsements 401-1, Endorsements Ranking 401-2, and Lead Facilitation Features 401-3.

5. A Mathematical Definition of the Class of Procedures that are Executed by Core Modules of the Invention

The mathematical definition herein represents one of the embodiments of the System pertaining to the technical processes for determining Agents' ranking within Endorsements of a specific Commodity or group of Commodities (“Ranking Procedure”) and the calculation of an Actual Bid price, which is the amount of monetary units the Agent is being actually charged for every Lead resulting from the Agent's privileged positioning within an Endorsement of a Commodity (“Pricing Procedure”).

Within System, let A denote the set of registered Agents and let C denote the set of available Commodities.

Within System a minimum allowed bid Mₘᵢₙ (“Minimum Allowed Bid”) may be set which specifies a threshold of monetary units which all placed bids need to meet, otherwise they would not be accepted by System.

Within System a default bit increment M_{inc}≥1 (“Default Bid Increment”) may be set to denote the default amount of monetary units by which a new bid needs to overcome an existing bid. In certain cases the default bid increment may not be observer.

System maintains a record of all Agents ranked for Endorsements of Commodities along with their current bids (“Endorsement Ranking”). Endorsement ranking may be viewed as a function e, which maps a Commodity c to a list of pairs e(c)=((a₁, m₁), (a₂, m₂), . . . , (aₙ, mₙ)), where aᵣ is the Agent who is the winner for the auction for rank r pertaining to an Endorsement of Commodity c, and mᵣ is the the amount of monetary units which Agent aᵣ will be charged for each lead generated within the Endorsement (“Actual Bid”). For purposes of brevity we hereafter define |e(c)|:=n to denote the maximum rank in the Endorsement Ranking e. Endorsement Rankings are visible and open to all Agents within System.

Definition: Minimum Cost condition. An Endorsement Ranking e is said to satisfy the Minimum Cost condition if each Actual Bid within e meets the minimum allowed bid threshold Mₘᵢₙ, as specified by equation (1) below:

eₘ(c)ᵣ≥Mₘᵢₙ for each c∈C and each r such that 1≤r≤|e(c)|. (1)

Definition: Ranking condition. An Endorsement Ranking e is said to satisfy the Ranking condition if the actual bids within e are arranged in descending order with respect to the rank, as specified by equation (2) below:

eₘ(c)ᵣ>eₘ(c)ₛ for each c∈C and each r and s, such that 1≤r<s≤|e(c)| (2)

Definition: Valid Endorsement Ranking. An Endorsement Ranking e is said to be valid (“Valid Endorsement Ranking”) if it satisfies both the Minimum Cost condition and the Ranking condition. System needs to ensure that it maintains only Valid Endorsement Rankings at any given moment.

Definition: Bidding mechanism. Within System Agents may place monetary bids against each individual Commodity c (“Individual Bid”). Within System Agents may specify the maximum amount of monetary units they accept to be charged for every lead resulting from the Agents' privileged positioning within an Endorsement of the Commodity c (“Maximum Did”). The Actual Bid, which is the amount of monetary units the Agent is being actually charged for every Lead resulting from the Agents' privileged positioning within an Endorsement of the Commodity c, is determined automatically by System by means of a ranking algorithm, such as the one specified below.

Definition: Bidding Configuration. System maintains a record of all Maximum Bids placed by Agents for position within Endorsements of Commodities, (“Bidding Configuration”). Bidding Configuration may be viewed as a function b mapping pairs of Agents a and Commodities c to the Maximum Bid of Agent a for Commodity c at any given moment. In case a has not placed any bid for c, then it could be defined that b(a, c):=0. The Bidding Configuration within System is not visible to individual Agents, so that their Maximum Bids are kept secret.

Definition: Minimum Bid condition. A Bidding Configuration b is said to satisfy the Minimum Bid condition if all Maximum Bids within b is equal to or exceeds the minimum allowed bid threshold Mₘᵢₙ, as specified by equation (3) below:

b(a,c)≥Mₘᵢₙ for each a∈A and c∈C, such that b(a,c)>0 (3)

Definition: Tie Breaker condition. A Bidding Configuration b is said to satisfy the Tie Breaker condition if all Maximum Bids within b are distinct as specified by equation (4) below:

b(a₁,c)≠b(a₂,c) for each a₁, a₂∈A and c∈C, such that a₁≠a₂ and b(aᵢ,c)>0 (4)

Definition: Valid Bidding Configurations. A Bidding Configuration is said to be valid (“Valid Bidding Configuration”) if it satisfies both the Minimum Cost condition and the Ranking condition. At any given moment only Valid Bidding Configurations need to be maintained within System. All Agent bids leading to a non-valid Bidding Configurations are rejected by System.

Definition: Auction condition. An Endorsement Ranking e is said to satisfy the Auction condition with respect to a Valid Bidding Configuration b if for any given Commodity c Agents are ordered within e in decreasing order with respect to their Maximum Bid within b, as specified by equation (5) below:

b(eₐ(c)ᵣ,c)>b(eₐ(c)ₛ,c) for each c∈C and each r and s, such that 1≤r<s≤|e(c)| (5)

Definition: Maximum Bid condition. An Endorsement Ranking e is said to satisfy the Maximum Bid condition with respect to a Valid Bidding Configuration b if the Actual Bid of any Agent a for any Commodity c does not exceed the Maximum. Bid of Agent a for Commodity c, as specified by equation (6) below:

b(eₐ(c)ᵣ,c)≥eₘ(c)ᵣ for each c∈C and each r such that 1≤r≤|e(c)| (6)

Definition: Fair Endorsement Rankings. An Endorsement Ranking e is called fair with respect to a Valid Bidding Configuration b (“Fair Endorsement Ranking”) if it satisfies the Auction condition and the Maximum Bid condition with respect to b. System needs to ensure that it generates and maintains only Fair Endorsement Rankings with respect to the current Bidding Configuration at any given moment.

Definition: Ranking algorithm. Hereafter a Ranking Algorithm refers to any algorithm within System, which produces an Endorsement Ranking e which is Valid and Fair with respect to a given Valid Bidding Configuration b. The algorithm specified below (the “Algorithm”) is an example of a Ranking Algorithm.

For each Commodity c∈C the following steps are performed:
1. A list A_{c} with all Agents who have placed a Maximum Bid for c is collected. Let the number of those Agents be denoted as n.
2. The list A_{c} is arranged in a decreasing order with respect to the maximum bid b(a, c). Let A_{c}=(a₁, a₂, . . . aₙ) after the arrangement, i.e., Agent aᵣ is given a rank r.
3. The Actual Bid mᵣ for Agent aᵣ is defined as follows:
   a. The Actual Bid of the Agent ranked at the last rank n is equal to the minimum bid within System, as specified by equation (7) below:

mₙ:=Mₘᵢₙ (7)
b. The Actual Bid of any other Agent aᵣ is equal to their Maximum Bid b(aᵣ, c), or equal to the Maximum Bid of the Agent aᵣ₊₁ ranked immediately below aᵣ increased with the default increment M_{inc}, whichever of those two amounts is less, as specified by equation (8) below:

mᵣ:=min(b(aᵣ₊₁,c)+M_{inc},b(aᵣ,c)) for 1≤r<n (8)
4. An Endorsement Ranking for the Commodity c is defined using the arrangement of Agents as specified in Step 2 each of them paired with their Actual Bid as specified in Step 3, as specified by equation (9) below:

e(c):=((a₁,m₁), . . . (aₙ,mₙ)) (9)

The Endorsement Ranking e satisfies the Minimum Cost condition because the Bidding Configuration b is Valid and, therefore, satisfies the Minimum Bid condition.

The Endorsement ranking e satisfies the Rank condition because the Bidding Configuration b is Valid and, therefore, satisfies the Tie Breaker condition, and, in addition, according to Step 4 of the Algorithm each Actual Bid mᵣ is strictly larger than the Maximum Bid b(aᵣ₊₁, c) of Aagent aᵣ₊₁ ranked immediately after Agent aᵣ, and this Maximum Bid b(aᵣ₊ᵢ, c) in turn is not less than the Actual Bid mᵣ₊₁ of Agent aᵣ₊₁ as specified by equation (10) below:

mᵣ>b(aᵣ₊₁,c)≥mᵣ₊₁ for 1≤r<n (10)

Therefore, the Endorsement Ranking e calculated by the Algorithm is Valid.

The Endorsement Ranking e satisfies the Auction condition with respect to the Bidding Configuration b because of the arrangement of Agents in Step 2 of the Algorithm, and, in addition, the Bidding Configuration b is Valid, therefore, it satisfies the Tie Breaker condition.

The Endorsement Ranking e satisfies the Auction condition with respect to the Bidding Configuration b because, according to Step 3 of the Algorithm, the Actual Bid mᵣ of each Agent aᵣ does not exceed the Maximum Bid of the same agent b(aᵣ, c), as specified by equation (11) below:

b(aᵣ,c)≥mᵣ for 1≤r≤n. (11)

Therefore, the Endorsement Ranking e calculated by the Algorithm is fair with respect to the Valid Bidding Configuration b.

Therefore, the Algorithm is a Ranking Algorithm.

Definition: Suggested Individual Bid. System may provide suggestions for Individual Bid amounts (“Suggested Individual Bids”) to Agents who wish to compete for a concrete rank r within an Endorsement of an individual Commodity c. The Suggested Individual Bids may be based on the current Endorsement Ranking e within System such that the Suggested Individual Bid falls between the Actual Bids for the Commodity c at ranks r-1 and r, or exceeds the Actual Bid for the Commodity c at rank 1 in case r=1. The Suggested Individual Bid amount need not guarantee that Agents placing the Individual Bid will actually win the auction rank r for the respective Commodity. The Suggested Individual Bid mechanism within System may be viewed as a list of functions bᵣ for each available rank r, each of the functions mapping a Valid Endorsement Ranking e and a Commodity c to a Suggested Individual Bid amount bᵣ(e, c) for rank r. Assuming e(c)=((a₁, m₁), . . . . (aₙ, mₙ)), the functions may be defined as follows:
The Suggested Micro Bid for rank 1 is equal to the highest Actual Bid m₁ plus the default increment M_{inc}, as specified by equation (12) below:

bᵢ(e,c):=m₁+M_{inc} (12)
The Suggested Micro Bid for any other rank r is equal to the Actual Bid mᵣ for rank r increased with the default increment M_{inc}, or the average amount of the Actual Bid mᵣ for rank r and the Actual Bid mᵣ₋₁ for the immediately preceding rank r-1, whichever of those two amounts is less, as specified by equation (13) below:

bᵣ(e,c):=min(avg(eₘ(c)ᵣ,eₘ(c)ᵣ₋₁),eₘ(c)ᵣ+M_{inc}), for 1<r≤|e(c)| (13)

Definition: Group Bid. Within System, Agents may select non-empty subsets of Commodities F⊆C by applying a set of Criteria available within System. Within System, an Agent a may place a maximum bid m for the selected set of Commodities F (“Group Bid”). Within System, this maximum bid m is applied as an Individual Bid to each individual Commodity within F, as specified by equation (14) below:

b(a,c):=m for each Commodity c∈F (14)

Definition: Suggested Group Bid. System may provide suggestions for Group Bid amounts (“Suggested Group Bids”) to Agents who wish to compete for a minimum rank r within all Endorsements of a specific non-empty subset of Commodities F. The Suggested Group Bids may be based on the current Endorsement Ranking e within System such that any of the Suggested Group Bids exceeds the Actual Bids at rank r for each Commodity c in the set of Commodities F. The mechanism for Suggested Group Bid mechanism within System may be viewed as a list of functions Bᵣ for each available rank r, each of the functions mapping a Valid Endorsement Ranking e and a set of Commodities F to a Suggested Group Bid amount Bᵣ(e, F) for rank r. The value of Bᵣ(e, F) may be defined as the maximum of all Suggested Individual Bids bᵣ(e, c) for all Commodities c in the set F, as specified in equation (14) below:

Bᵣ(a,F):=max{bᵣ(a,c)|c∈F} for each rank r and each a∈A (14)

Definition: Time Limit. Within System, Agents may associate a time limit with an Individual Bid or a Group Bid (“Time Limit”), such that the respective Bid is automatically withdrawn when the Time Limit expires.

Definition: Leads Limit. Within System, Agents may associate a Leads limit with an Individual Bid or a Group Bid (“Leads Limit”), such that the respective Bid is automatically withdrawn after the number of Leads pertaining to Endorsements related to the respective Bid becomes equal to or exceeds the Leads Limit.

Definition: Budget Limit. Within System, Agents may associate a budget limit with an Individual Bid or a Group Bid (“Budget Limit”), such that the respective Bid is automatically withdrawn after the sum of all costs associated with each individual Lead pertaining to Endorsements related to the respective Bid becomes equal to or exceeds the Budget Limit.

### INDUSTRIAL APPLICABILITY

Real estate sites for property buyers, sellers, renters, and real estate licensees.

Vehicle and machinery dealerships for vehicle buyers, sellers, and renters.

Resellers of admission tickets and vouchers for cinematic projections, theatrical performances, music concerts, tourist attractions, and any other type of public entertainment performances for ticket resellers, end-customers, entertainment venues.

Travel agencies reselling journey tickets for travel via air, ground, rail, sea, and any other means of transportation for ticket resellers, end-customers, and transport service companies.

What is claimed is:

1. A method for promoting Agents within Endorsements of Commodities, comprising:
storing and managing lists of Commodities and information about them;
storing and managing lists of registered Agents and information about them;
managing and conducting auctions for privileged positions of Agents within Endorsements of Commodities;
displaying Endorsements of Commodities associated with lists of Agents to Prospects.

2. The method of claim 1, further characterized by a process for collecting bids from Agents relating to their Target Commodities.

3. The method of claim 2, further characterized by a Ranking Algorithm for conducting an auction pertaining to Commodity Endorsements and assigning a rank to each Agent in accordance with the Agent's bid for the respective Commodity.

4. The method of claim 3, further characterized by a Ranking procedure for calculating an actual bid price within an auction pertaining to a Commodity Endorsement and to an Agent who is assigned a rank within the auction, such that the calculated actual bid price is potentially lower than the bid placed by the Agent, but still higher than the bid placed by the Agent who is assigned the immediately succeeding rank within the same auction.

5. The method of claim 4, further characterized by visually emphasising promotions of Agents within a Commodity Endorsement being displayed to Prospects in accordance with their rank as calculated by a Ranking procedure.

6. The method of claim 5, further characterized by providing means to establish a contact between Prospect and Agents within Commodity Endorsements.

7. The method of claim 1, further characterized by the enhancement of Commodity Endorsements by collecting, aggregating, and presenting to Prospects information from external sources that is relevant to the corresponding Commodities.

8. The method of claim 6, further characterized by displaying Commodity Endorsements associated with Agents' ranking provided by an external source.

9. The method of claim 6, further characterized by providing Agents the ability and choice to place a bid for groups of Target Commodities at once as well as for any individual Target Commodity.

10. The method of claim 9, further characterized by providing Agents with specific Criteria which are relevant to the types of Commodities, thereby supporting Agents to optimize the identification of the Agents' Target Commodities.

11. The method of claim 10, further characterized by maintaining an account of available funds for each Agent, such that whenever Agent comes in contact with Prospect by means of the Agent contact information displayed in a Commodity Endorsement, the amount of the Actual Bid for the respective rank within the respective Commodity Endorsement as calculated by a Ranking procedure is subtracted from Agent's account;

12. The method of claim 11, further characterized by the discontinuation of Agents' bids in the event of unavailability of sufficient funds in Agent's account.

13. The method of claim 12, further characterized by the suggestion of bid amounts to Agents willing to compete for a rank respective to individual Target Commodities.

14. The method of claim 13, further characterized by the suggestion of bid amounts to Agents willing to compete for a rank respective to groups of Target Commodities.

15. The method of claim 14, further characterized by the calculation of suggested bid amounts respective to an individual Target Commodity or groups of Target Commodities based on the current rankings within Endorsements of the respective Target Commodities.

16. The method of claim 15, further characterized by the calculation of Suggested Individual Bids to support Agents determine the bid amounts to place for the corresponding Target Commodity.

17. The method of claim 16, further characterized by the calculation of Suggested Group Bids to support Agents determine the bid amounts to place for the corresponding Target Commodities.

18. A computer system for Ranking Agent Promotions within Commodity Endorsements, comprising:
a client-server configuration facilitating the execution of computer programs for:
storing and managing lists of Commodities and information relating to such commodities;
storing and managing lists of registered Agents and information relating to such Agents;
managing and conducting auctions for privileged positions of Agents within Endorsements of Commodities;
displaying Endorsements of Commodities associated with lists of Agents to Prospects.

19. The system of claim 18, wherein an account is associated with each Agent within the system, which is accessible by means of identity and access identifiers.

20. The system of claim 18, further characterized by a module for managing fund accounts of discrete monetary units assigned to Agents to be used within the system.

21. The system of claim 20, wherein Agents are able to obtain monetary units for their funds account by the use of legal tender, cash or non-cash methods of payment, bank transfer orders, third-party payment systems, electronic funds transfer, and digital currencies.

22. The system of claim 21, wherein Agents are able to input monetary bids pertaining to one or more Target Commodities within the System in order to compete with each other for a privileged visual display within Endorsements of their Target Commodities.

23. The system of claim 22, wherein a distinct rank is associated with each Agent relative to each Commodity against which the Agent has placed a bid, such that the rank is in accordance with the amount of the bid placed by the Agent relative to the amount of the bids placed by other Agents.

24. The system of claim 23, wherein the rank is calculated by a Ranking Procedure.

25. The system of claim 23, wherein an actual bid price is calculated within an auction pertaining to a Commodity Endorsement and to an Agent who is assigned a rank within the auction, such that the calculated actual bid price can be lower than the bid placed by the Agent, but still higher than the bid placed by the Agent who is assigned the immediately succeeding rank within the same auction.

26. The system of claim 25, wherein the Actual Bid price is calculated by a Pricing Procedure.

27. The system of claim 25, wherein Agents can access real time information about activity of other Agents pertaining to Commodities, such as the Rankings and the Actual Bids pertaining to an individual Commodity Endorsement, as well as aggregated reports about Commodities and features of Commodities that receive Actual Bids within a certain amount range.

28. The system of claim 27, wherein Agents may input contact and profile information to be displayed in Endorsements of Commodities that they are associated with.

29. The system of claim 28, wherein Agents whose ranks with respect to a Commodity are calculated above the ranks of other Agents receive privileged visual display within the Endorsement of the said Commodity corresponding to their calculated rank.

30. The system of claim 29, wherein Prospects are provided with means to establish a contact with an Agent within Commodity Endorsements which the Agent is associated with.

31. The system of claim 30, further characterized by a connection with one or more external systems containing information about Commodities.

32. The system of claim 31, further characterized by a connection with one or more external systems for displaying Endorsements of Commodities;

33. The system of claim 32, further characterized by providing Agents with specific Criteria which are relevant to the types of Commodities, thereby supporting Agents to optimize the identification of the Agents' Target Commodities.

34. The system of claim 33, wherein Agents can define the Criteria identifying their Target Commodities in order to specify the set of Target Commodities for which they compete and place bids.

35. The system of claim 34, wherein an account of available funds for each Agent is maintained, such that whenever Agent comes in contact with Prospect by means of the Agent contact information displayed in a Commodity Endorsement, the amount of the Actual Bid for the respective rank within the respective Commodity Endorsement as calculated by a Ranking procedure is subtracted from Agent's account;

36. The system of claim 35, further characterized by the discontinuation of Agents' bids in the event of unavailability of sufficient funds in Agent's account.

37. The system of claim 36, further characterized by a user interface module, allowing Agents to place bids of predefined amounts suggested by the system for individual Target Commodities, in addition to allowing Agents to input a custom bid amount via numeric input.

38. The system of claim 37, further characterized by a user interface module, allowing Agents to place bids of predefined amounts suggested by the system for groups of Target Commodities, in addition to allowing Agents to input a custom bid amount via numeric input.

39. The system of claim 38, further characterized by the calculation of Agents ranks by a Ranking Procedure.

40. The system of claim 38, further characterized by a geographic map interface representing real time visual information about the types of features of Commodities that are accessed by Prospects, wherever geographic location is among the identifiers of said Commodities.

41. The system of claim 39, wherein Agents may set a Time Limit for a bid relative to an individual Target Commodity or a group of Target Commodities, such that Agent's bid is withdrawn after the Time Limit expires.

42. The system of claim 39, wherein Agents may associate a Leads Limit relative to an individual Target Commodity or a group of Target Commodities, such that Agent's bid is withdrawn whenever the number of established contacts with Prospects through Endorsements relating to the respective Target Commodity or group of Target Commodities exceeds the Leads Limit.

43. The system of claim 39, wherein Agents may associate a Budget Limit relative to an individual Target Commodity or a group of Target Commodities, such that Agent's bid is withdrawn whenever the sum of all charges to Agent's funds account associated with contacts with Prospects through Endorsements relating to the respective Target Commodity or group of Target Commodities exceeds said Budget Limit.
